(19) United States
(12) Patent Application Publication
(10) Pub. No.: US 2016/0132892 A1
(43) Pub. Date: May 12, 2016

(54) METHOD AND SYSTEM FOR ESTIMATING CUSTOMER SATISFACTION

(71) Applicant: Bluenose Analytics, Inc., San Francisco, CA (US)

(72) Inventors: Borong Zhou, Pleasanton, CA (US); Todd Graham, San Francisco, CA (US); Don MacLennan, Palo Alto, CA (US)

(21) Appl. No.: 14/538,960

(22) Filed: Nov. 12, 2014

(51) Int. Cl. G06Q 30/00

(52) U.S. Cl. CPC G06Q 30/016

(57) ABSTRACT

Method, system, and programs for estimating customer satisfaction associated with a customer are disclosed. In one example, a plurality of time series is obtained. Each time series comprises observations for one of a plurality of events associated with the customer. Each observation for each of the events is made with respect to a time period. A plurality of individual measures is estimated. Each of the individual measures is associated with one of the plurality of events. Each individual measure is estimated based on a time series including a plurality of observations associated with the event. Information is received indicative of a number of events selected from the plurality of events. An aggregated measure is computed indicative of a degree of satisfaction of the customer based on individual measures associated with the number of events.

### TECHNICAL FIELD

The present teaching relates to methods, systems and programming for estimating customer satisfaction.

### BACKGROUND

In reoccurring revenue businesses like online services, service providers need to understand and optimize their business based on some critical metrics. One of these metrics is related to customer satisfaction, a measure of how products and/or services supplied by a provider meet or surpass customer expectation. Estimated or predicted customer satisfaction can be useful to predict a churn rate, i.e. percentage of contractual customers or subscribers who leave (or fail to renew with) a supplier.

However, existing techniques for estimating customer satisfaction are limited to isolated observations such as counting of occurrences of certain events related to a customer. Such estimation merely reflects a snap shot of what is going on in time and does not provide an assessment of the satisfaction on an on-going basis. In most situations, it is more important to understand customer satisfaction in a continuous manner or in a predictive manner so that any issue or concern can be addressed before it causes long-term dissatisfaction and/or churning.

Therefore, there is a need to provide an improved solution for assessing customer satisfaction to solve the above-mentioned problems.

### SUMMARY

The teachings disclosed herein relate to methods, systems, and programming for estimating customer satisfaction associated with a customer.

In one example, a method implemented on a computer having at least one processor, a storage, and a telecommunication platform for estimating customer satisfaction associated with a customer is disclosed. A plurality of time series is obtained. Each time series comprises observations for one of a plurality of events associated with the customer. Each observation for each of the events is made with respect to a time period. A plurality of individual measures is estimated. Each of the individual measures is associated with one of the plurality of events. Each individual measure is estimated based on a time series including a plurality of observations associated with the event. Information is received indicative of a number of events selected from the plurality of events. An aggregated measure is computed indicative of a degree of satisfaction of the customer based on individual measures associated with the number of events.

In another example, a system having at least one processor, a storage, and a telecommunication platform for estimating customer satisfaction associated with a customer is disclosed. The system comprises an event-based time series generator, an event-based customer satisfaction score estimator, a significant event determiner, and a customer-based satisfaction estimator. The event-based time series generator is configured to obtain a plurality of time series. Each time series comprises observations for one of a plurality of events associated with the customer. Each observation for each of the events is made with respect to a time period. The event-based customer satisfaction score estimator is configured to estimate a plurality of individual measures, each of which is associated with one of the plurality of events. Each individual measure is estimated based on a time series including a plurality of observations associated with the event. The significant event determiner is configured to receive information indicative of a number of events selected from the plurality of events. The customer-based satisfaction estimator is configured to compute an aggregated measure indicative of a degree of satisfaction of the customer based on individual measures associated with the number of events.

Other concepts relate to software for estimating customer satisfaction associated with a customer. A software product, in accord with this concept, includes at least one machine-readable non-transitory medium and information carried by the medium. The information carried by the medium may be executable program code data regarding parameters in association with a request or operational parameters, such as information related to a user, a request, or a social group, etc.

In one example, a machine-readable tangible and non-transitory medium having information recorded thereon for estimating customer satisfaction associated with a customer is disclosed. The information, when read by the machine, causes the machine to perform the following. A plurality of time series is obtained. Each time series comprises observations for one of a plurality of events associated with the customer. Each observation for each of the events is made with respect to a time period. A plurality of individual measures is estimated. Each of the individual measures is associated with one of the plurality of events. Each individual measure is estimated based on a time series including a plurality of observations associated with the event. Information is received indicative of a number of events selected from the plurality of events. An aggregated measure is computed indicative of a degree of satisfaction of the customer based on individual measures associated with the number of events.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a high level depiction of an exemplary networked environment for estimating customer satisfaction, according to an embodiment of the present teaching;

FIG. 2 is a high level depiction of another exemplary networked environment for estimating customer satisfaction, according to an embodiment of the present teaching;

FIG. 3 illustrates an exemplary diagram of a customer satisfaction estimation engine for estimating customer satisfaction, according to an embodiment of the present teaching;

FIG. 4 illustrates different time series for different events and different customers, according to an embodiment of the present teaching;

FIG. 5A is a flowchart of an exemplary process performed by a customer satisfaction estimation engine, according to an embodiment of the present teaching;

FIG. 5B is a flowchart of an exemplary process performed by a significant event determiner, according to an embodiment of the present teaching;

FIG. 6 illustrates an exemplary diagram of an event-based time series generator in a customer satisfaction estimation engine, according to an embodiment of the present teaching;

FIG. 7 is a flowchart of an exemplary process performed by an event-based time series generator, according to an embodiment of the present teaching;

FIG. 8 illustrates an exemplary diagram of an event-based customer satisfaction estimator in a customer satisfaction estimation engine, according to an embodiment of the present teaching;

FIG. 9 illustrates one example of time series for observations of an event and the corresponding event-based satisfaction score at different time periods, according to an embodiment of the present teaching;

FIG. 10 is a flowchart of an exemplary process performed by an event-based customer satisfaction estimator, according to an embodiment of the present teaching;

FIG. 11 illustrates an exemplary diagram of a customer satisfaction trend reporter in a customer satisfaction estimation engine, according to an embodiment of the present teaching;

FIG. 12 illustrates one example of trend estimation for a customer, according to an embodiment of the present teaching;

FIG. 13 illustrates one example of classifying different customers into different categories, according to an embodiment of the present teaching;

FIG. 14 is a flowchart of an exemplary process performed by a customer satisfaction trend reporter, according to an embodiment of the present teaching;

FIG. 15 depicts a general mobile device architecture on which the present teaching can be implemented; and

FIG. 16 depicts a general computer architecture on which the present teaching can be implemented.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The present disclosure describes method, system, and programming aspects of estimating customer satisfaction and predicting a trend of customer satisfaction. Customer satisfaction assessment is useful to both a service provider and the customer who receives the service. To predict a satisfaction level of a customer in a future time period, the customer's satisfaction levels can be assessed in terms of past time periods. A trend to occur in the near future can be estimated based on, e.g., the dynamics in satisfaction levels as occurred in the past time periods.

Accordingly, to estimate the customer satisfaction and assess a satisfaction trend for a customer, a system in the present teaching generates a plurality of time series, each of which corresponds to an event associated with the customer. For example, events associated with a customer may include a plurality of activities such as login, logout, save, click, forward, share, or any combination thereof. A time series corresponding to an event may be denoted as a¹, a², a³ . . . , where a¹ represents an observation made during time period 1, a² represents an observation made during time period 2, a³ represents an observation made during time period 3, so on and so forth. An observation may include a count of the occurrences of the underlying event observed during a given time period. The time periods may be fixed (each day) or flexible (each day in some period of time and each week in a different time period). The time periods may be continuous (every day) or periodic (every day for the first week of each month). The time periods may also be designated periods determined based on the needs of an underlying application. For instance, the time period for making observations of a certain event may be around only holiday weekend days. The time periods may also be season dependent, e.g., make observations every day around the Christmas, Mother's day, and Labor Day weekend.

Based on observations in a time series related to each event, an individual measure can be estimated to estimate the customer's satisfaction determined in accordance with that event. The specific time at which the observations were made may be taken into consideration in computing the individual measure on customer satisfaction. For example, an observation made in a time period closer to a current time (at which the individual measure estimating the customer satisfaction is computed) may contribute more to the individual measure than that made in a time period further in the past.

As each event may signify a customer's satisfaction, individual measures with respect to different time series generated based on observations on different events may be computed. To estimate a customer's satisfaction in consideration of observations of different types of events, individual measures computed based on time series with respect to different types of event may be combined to estimate the customer's satisfaction. In accordance with various embodiments of the present teaching, an aggregated measure indicative of satisfaction of the customer regarding the service can be computed based on individual measures associated with different events. The individual measures to be included in computing the aggregated measure of a customer's satisfaction may be selected based on various considerations. For example, types of events that are considered to be more relevant to or more indicative of a customer's satisfaction may be determined based on past data that record observations of events associated with customers and the outcomes associated with those customers (e.g., dropping the services, remaining loyal to the services, or service requests for additional services). Correlations between types of events and levels of satisfaction of customers may be determined based on such historical data using, e.g., statistical analysis. As another example, determination may also be made based on expert's assessment or evaluation.

Either all or selected set of the individual measures (characterizing customer satisfaction based on observations of a specific type of event) may be used to compute the aggregated measure characterizing customer satisfaction based on observations of multiple events. Different individual measures corresponding to different underlying events may be selected based on a degree of importance of each individual event.

The individual measure and/or the aggregated measure may be determined at certain points of time or periodically. For instance, the estimation can be made every week or every month. The estimation may also be made whenever it is needed. The points of time to estimate individual measures and/or aggregated measure may or may not overlap. For example, each time the individual measures are computed, the aggregated measure may also be computed. Alternatively, the aggregated measure may be estimated less frequent than the individual measures. That is, individual measures and the aggregated measure may correspond to different granularities in terms of time.

Through the individual measures and/or the aggregated measures, the customer satisfaction can be estimated based on continuous observations of customer's on-going activities (instead of snap shot). The individual/aggregated measures estimated at different points of time also form time series that can be further utilized to predict a trend of customer satisfaction. In some embodiments of the present teaching, a trend of satisfaction with respect to a customer may be estimated based on aggregated measures estimated at different points of time with respect to the customer. Similarly, the trend may also be estimated based on individual measures associated with the customer. Such prediction may be based on an extrapolation of a curve derived by fitting a time series of aggregated measures with an analytical model.

In addition, the present teaching may also qualify the estimated quantitative level of satisfaction and classify level of satisfaction into categories that are meaningful for business operation. For example, while aggregated measures may fall within a range of [0%, 100%], a specific measure of 65% may be qualified as “moderately satisfied” to assist an operator to understand, in qualified terms, the level of satisfaction in a verbal form. Similarly, the trend prediction estimated based on, e.g., extrapolation of a fitted model, may also be qualified. For example, if the extrapolation indicates that the next predicted aggregated measure will be higher than the previous one, the qualified classification of the trend prediction can be “upward.”

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

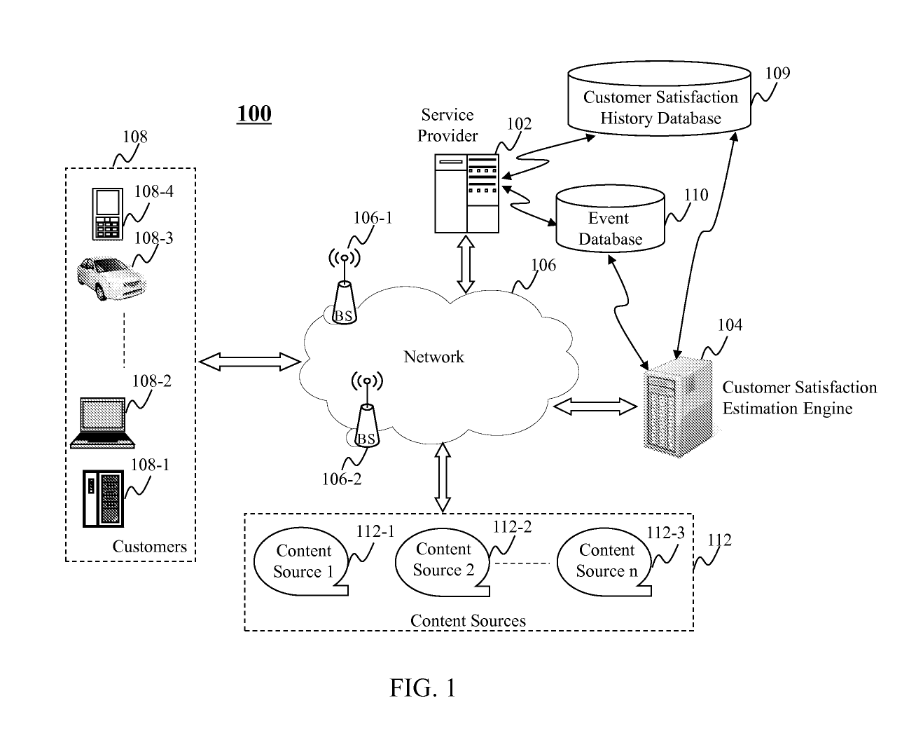

FIG. 1 is a high level depiction of an exemplary networked environment 100 for estimating customer satisfaction, according to an embodiment of the present teaching. In FIG. 1, the exemplary networked environment 100 includes a service provider 102, a customer satisfaction estimation engine 104, a network 106, one or more customers 108, a customer satisfaction history database 109, an event database 110, and content sources 112. The network 106 may be a single network or a combination of different networks. For example, the network 106 may be a local area network (LAN), a wide area network (WAN), a public network, a private network, a proprietary network, a Public Telephone Switched Network (PSTN), the Internet, a wireless network, a virtual network, or any combination thereof. In an example of Internet advertising, the network 106 may be an online advertising network or ad network that is a company connecting advertisers to web sites that want to host advertisements. The network 106 may also include various network access points, e.g., wired or wireless access points such as base stations or Internet exchange points 106-1 . . . 106-2, through which a data source may connect to the network 106 in order to transmit information via the network 106.

Customers 108 may be of different types such as customers connected to the network 106 via desktop computers 108-1, laptop computers 108-2, a built-in device in a motor vehicle 108-3, or a mobile device 108-4. A customer 108 may send a request to the service provider 102 via the network 106 and receive a response to the request from the service provider 102. The service provider 102 may be a publisher or a search engine that can provide content based on the request.

The customer satisfaction estimation engine 104 can help the service provider 102 to assess and/or predict satisfactions of the customer 108. In this embodiment, the customer satisfaction estimation engine 104 directly connects to the network 106 and can communicate with the customers 108 directly via the network 106.

The customer satisfaction history database 109 may store satisfaction history information of the customers 108. The satisfaction history information may include satisfaction levels of different customers regarding services provided by the service provider 102, based on the customers' explicit and/or implicit feedbacks. The satisfaction history information may be obtained by either the service provider 102 or the customer satisfaction estimation engine 104. The satisfaction history information can be utilized by the customer satisfaction estimation engine 104 to predict a customer's satisfaction level in the future.

The event database 110 may store observations of different events associated with different customers 108. An observation of an event may include a number of occurrences of the event during a period of time and/or a time stamp signifying the time at which the observation is made. The observations of events in the event database 110 may be collected either by the service provider 102 or by the customer satisfaction estimation engine 104. The customer satisfaction estimation engine 104 may retrieve the observations regarding an event associated with a customer from the event database 110 and generate an event-based time series corresponding to the event and the customer.

The content sources 112 include multiple content sources 112-1, 112-2 . . . 112-3, such as vertical content sources. A content source 112 may correspond to a website hosted by an entity, whether an individual, a business, or an organization such as USPTO.gov, a content item provider such as cnn.com and Yahoo.com, a social network website such as Facebook.com, or a content feed source such as tweeter or blogs. The service provider 102 and the customer satisfaction estimation engine 104 may access information from any of the content sources 112-1, 112-2 . . . 112-3. For example, the service provider 102 may fetch content from the content sources 112 to provide an online service.

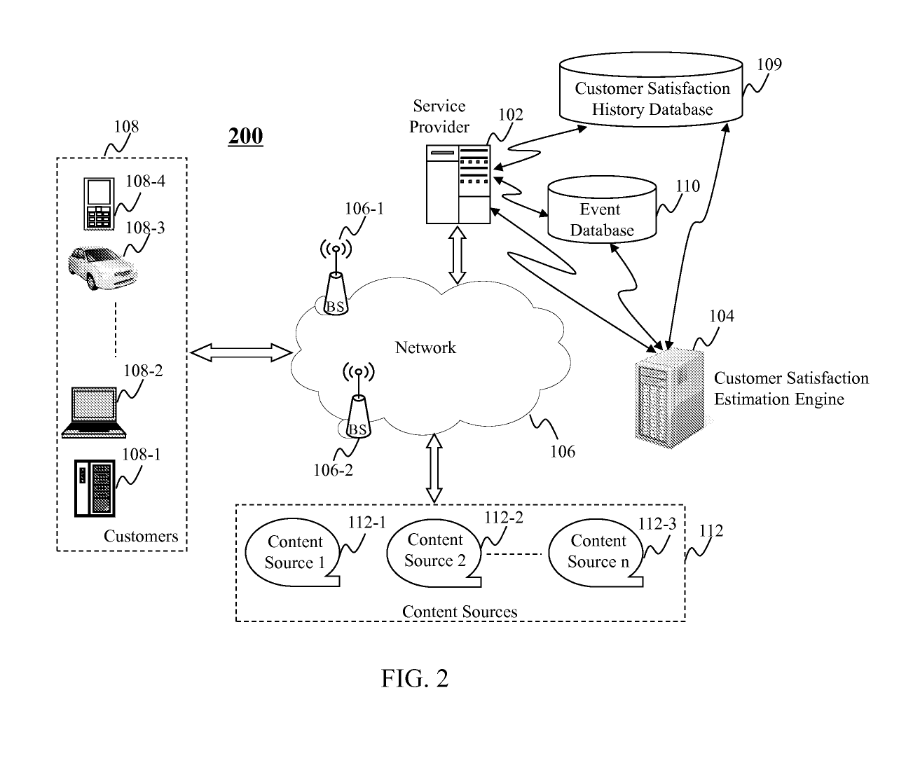

FIG. 2 is a high level depiction of another exemplary networked environment 200 for estimating customer satisfaction, according to an embodiment of the present teaching. The exemplary networked environment 200 in this embodiment is similar to the exemplary networked environment 100 in FIG. 1, except that the customer satisfaction estimation engine 104 in this embodiment connects to the network 106 via the service provider 102. For example, the customer satisfaction estimation engine 104 may serve as a backend of the service provider 102 to assess and/or predict customer satisfactions of the customers 108 communicating with the service provider 102.

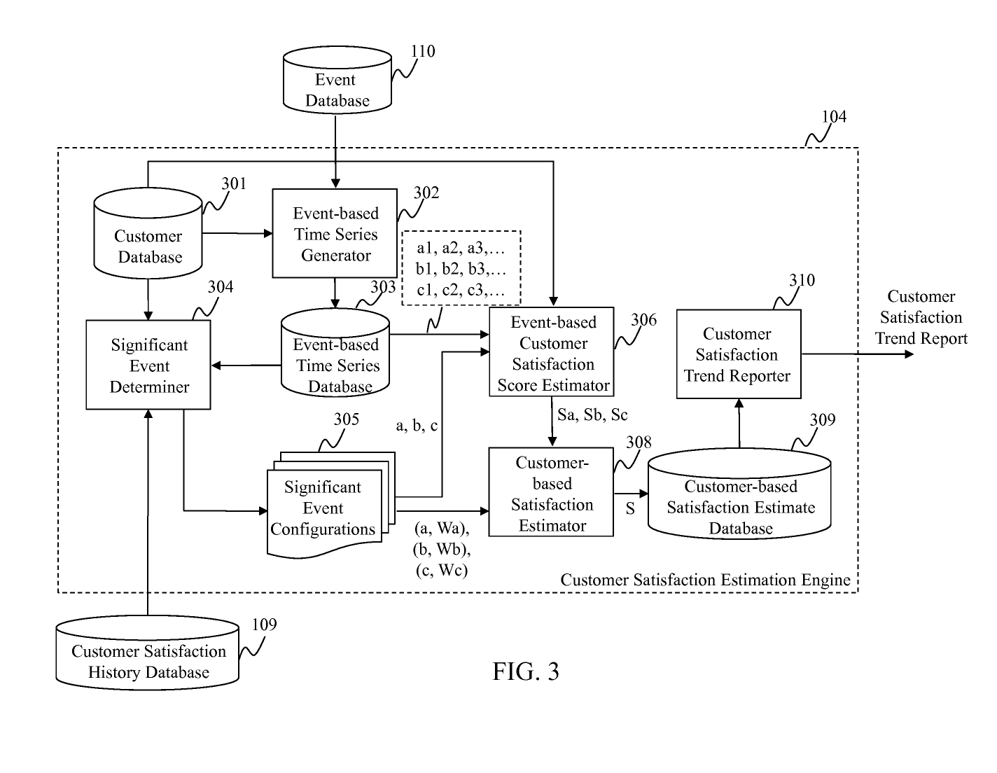

FIG. 3 illustrates an exemplary diagram of a customer satisfaction estimation engine 104 for estimating customer satisfaction, according to an embodiment of the present teaching. The customer satisfaction estimation engine 104 may be in an exemplary networked environment, e.g., the networked environment 100 in FIG. 1 or the networked environment 200 in FIG. 2. The customer satisfaction estimation engine 104 in this example includes an event-based time series generator 302, a significant event determiner 304, an event-based customer satisfaction score estimator 306, a customer-based satisfaction estimator 308, and a customer satisfaction trend reporter 310. The event-based time series generator 302 in this example retrieves observations of events from the event database 110. An observation of an event retrieved by the event-based time series generator 302 includes a number of occurrences of the event during a period of time and a time stamp signifying the time at which the observation is made. The event-based time series generator 302 also identifies a customer associated with each retrieved observation and generates an event-based time series related to each event based on the retrieved observations. A time series associated with an event is a list of number of occurrences of the event observed in periods of time. The periods of time may be fixed (each day) or flexible (each day in some period of time and each week in a different time period). The time periods may be continuous (every day) or periodic (every day for the first week of each month). The time periods may also be designated periods determined based on the needs of an underlying application. For instance, the time period for making observations of a certain event may be around only holiday weekend days. The time periods may also be season dependent, e.g., make observations every day around the Christmas, Mother's day, and Labor Day weekend. The time periods may be dynamically adjustable based on at least one of the above mentioned criteria.

For example, the event-based time series generator 302 retrieves an observation from the event database 110, where the observation was collected in time period 2 and related to event aᵢ₁ associated with customer i. The event-based time series generator 302 may extract customer related information from the retrieved observation and match the customer related information to a customer's identification (ID) stored in a customer database 301 in the customer satisfaction estimation engine 104. The customer database 301 stores different customers' IDs and other information, e.g. demographic information. In one embodiment, the customer database 301 may be configured in the service provider 102 and the customer ID may be identified by the service provider 102 and forwarded to the customer satisfaction estimation engine 104. After identifying customer i, the event-based time series generator 302 may determine that the observation was collected in time period 2 and related to event aᵢ₁. Therefore, the event-based time series generator 302 will increase the count of occurrences aᵢ₁² by one and continue to retrieve the next observation. Eventually, after all the needed observations in the event database 110 are retrieved and processed by the event-based time series generator 302, the event-based time series generator 302 generates a plurality of event-based time series, each of which corresponding to an event associated with a customer.

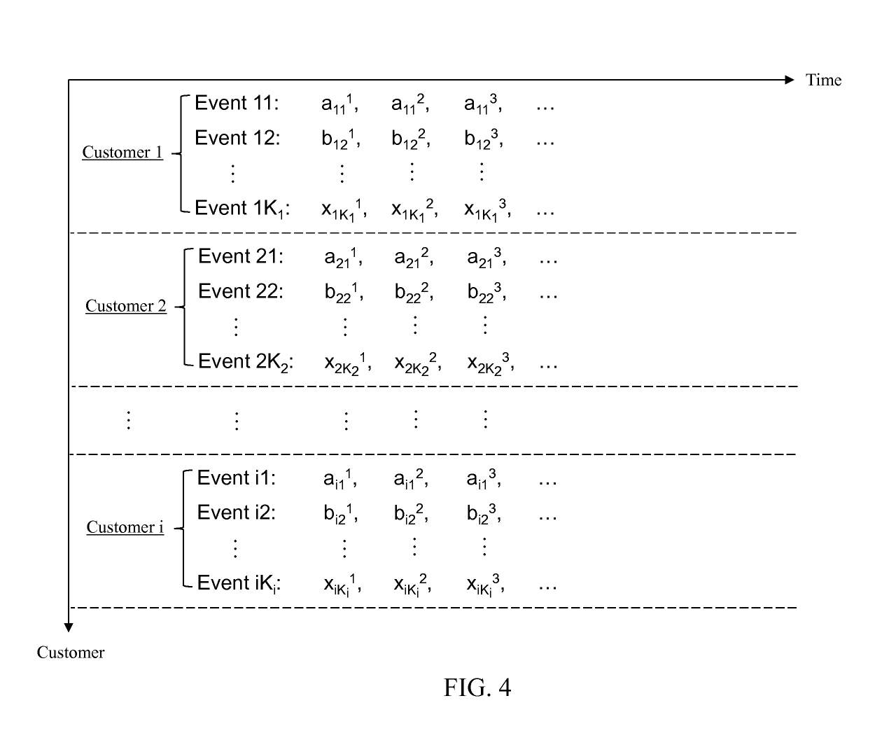

FIG. 4 illustrates different time series for different events and different customers, according to an embodiment of the present teaching. As shown in FIG. 4, each customer may be associated with different events. For example, customer 1 is associated with K₁ events: event 11, event 12 . . . event 1K₁; customer 2 is associated with K₂ events: event 21, event 22 . . . event 2K₂; etc. Corresponding to each event, a time series comprising observations made in different time periods is shown in FIG. 4. For example, a time series corresponding to event 11 comprises a₁₁¹, a₁₁², a₁₁³, . . . ; a time series corresponding to event 2K₂ comprises x_{2K2}¹, x_{2K2}², x_{2K2}³, . . . ; etc. An observation, e.g. a₁₁¹, is made within a period of time 1 and may include a count of the occurrences of event a₁₁. It can be understood that the events do not have to be initiated by the customer, but can be associated with the customer.

Back to FIG. 3, the generated event-based time series at the event-based time series generator 302 may be sent to an event-based time series database 303 in the customer satisfaction estimation engine 104 for storing. For example, the event-based time series database 303 may store all of the time series illustrated in FIG. 4 with indices so that each time series can be retrieved for processing.

The event-based customer satisfaction score estimator 306 in this example determines whether it is time to estimate customer satisfaction. In one example, the customer satisfaction may be estimated after each predetermined time period, e.g. each hour, each day, etc. In another example, the customer satisfaction may be estimated upon a request received by the customer satisfaction estimation engine 104, e.g. from the service provider 102. After determining that it is time to estimate customer satisfaction for a customer, the event-based customer satisfaction score estimator 306 may retrieve one of significant event configurations 305 stored in the customer satisfaction estimation engine 104 for the customer. Each significant event configuration 305 includes information about which events are significant for assessing the customer's satisfaction.

Significant events may be determined based on types of events that are considered to be more relevant to or more indicative of a customer's satisfaction. For example, although a customer is involved in events like login, logout, and click, an analysis may show that only events including save, share, and/or forward can contribute significantly to the customer's satisfaction assessment. The analysis may be performed based on past data that record observations of events associated with customers and the outcomes associated with those customers (e.g., dropping the services, remaining loyal to the services, or service requests for additional services). Correlations between types of events and levels of satisfaction of customers may be determined based on such historical data using, e.g., statistical analysis. As another example, determination may also be made based on expert's assessment or evaluation. The analysis may be performed by the significant event determiner 304, either in real-time or during offline.

Each significant event configuration 305 may also include information about weights associated with the significant events. A weight associated with a significant event may be a coefficient indicative of the importance of the significant event. For example, in one significant event configuration, weights associated with the significant events save, share, and forward are 0.2, 0.5, and 0.3; in another significant event configuration, weights associated with the same significant events are 0.1, 0.7, and 0.2.

The significant event determiner 304 in this example determines significant events and generates different significant event configurations based on the significant events. The significant event determiner 304 may retrieve customer information from the customer database 301. For each customer, the significant event determiner 304 may retrieve the customer's satisfaction history from the customer satisfaction history database 109, retrieve event-based time series from the event-based time series database 303, and determine significant events and their associated weights for the customer.

In one embodiment, the significant events and associated weights can be determined based on the customer's satisfaction history including some explicit and/or implicit inputs from the customer indicating his/her satisfaction level regarding an event. For example, a customer may explicitly input that a bookmarking event associated with the customer represents at least 80% satisfaction, so that the bookmarking event can be determined to be a significant event for assessing the customer's satisfaction. A customer may also input a likelihood that he/she will unsubscribe from the service.

In another embodiment, the significant events and associated weights can be determined based on event-based time series stored in the event-based time series database 303 related to the customer in addition to the customer's satisfaction history. For example, based on event-based time series related to events including share, save, bookmark, etc., the significant event determiner 304 may determine different correlations each of which between one of the events and a likelihood that the customer will unsubscribe. The significant event determiner 304 may select events having the highest correlations with the unsubscribe-likelihood as the significant events, and determine their associated weights based on the correlations. For example, if four events having correlations 75%, 75%, 50%, 50%, respectively are selected as significant events, their weights can be normalized as 0.3, 0.3, 0.2, 0.2 respectively, wherein each weight is proportional to its corresponding correlation and the sum of the weight equals to one.

In yet another embodiment, the significant events and associated weights can be determined based on information received from a manager. For example, a domain expert for the service may provide inputs regarding which events can contribute most significantly to customer satisfaction assessment.

In an additional embodiment, the events generated by specific users of the system may factor in more greatly in determining the overall scores. For example, if the software is for enterprises, an executive interacting with the software may be weighted higher than a more junior user.

The significant event determiner 304 may generate significant event configurations based on the determined significant events and their associated weights. The generated significant event configurations 305 are stored with references to different customers. In one example, different customers may be assigned or referred to by different significant event configurations. In another example, same significant event configuration may be assigned to some customers having common characteristics, e.g. same sex, same age range, same operating system, same browser, etc. This may be based on correlation analysis performed by the significant event determiner 304 or inputs from a domain expert.

As discussed before, after determining that it is time to estimate customer satisfaction for a customer, the event-based customer satisfaction score estimator 306 may retrieve customer information of the customer from the customer database 301 and retrieve one of the significant event configurations 305 for the customer based on the retrieved customer information. The event-based customer satisfaction score estimator 306 determines the significant events based on the retrieved significant event configuration and retrieves event-based time series for each significant event. The event-based customer satisfaction score estimator 306 then estimates an event-based customer satisfaction for each significant event. Each event-based customer satisfaction may be estimated based on an individual measure determined based on a retrieved event-based time series, e.g. using a time based model.

In one example, a time based model may be a time decay model where an observation in a time period closer to a current time has more effect on the individual measure compared to an observation in a time period further in the past of the same time series. In other examples, a time based model may be a periodic model or any time dependent model. According to a periodic model, for example, observations in a morning time period always have a first same weight; observations in an afternoon time period always have a second same weight; observations in an evening time period always have a third same weight, such that weights for different time periods are in a periodic manner.

For example, as shown in FIG. 3, based on significant event configuration retrieved by the event-based customer satisfaction score estimator 306 for a customer, significant events for the customer are a, b, and c. The event-based customer satisfaction score estimator 306 retrieves three time series: a1, a2, a3, . . . ; b1, b2, b3, . . . ; c1, c2, c3, . . . ; corresponding to events a, b, and c, respectively. Based on the three time series, the event-based customer satisfaction score estimator 306 generates three individual measures Sa, Sb, and Sc, representing the customer's current satisfaction regarding events a, b, and c, respectively.

The individual measures for the number of events can be determined based on their relevance to customer satisfaction, according to one of the above mentioned time based models. In accordance with one time based model, the event-based customer satisfaction score estimator 306 determines a difference between each pair of two adjacent observations in the time series, normalizes the difference from each pair of adjacent observations, and computes the individual measure for the time series based on the normalized differences for pairs of adjacent observations.

The event-based customer satisfaction score estimator 306 may send the three individual measures Sa, Sb, and Sc to the customer-based satisfaction estimator 308. The customer-based satisfaction estimator 308 in this example estimates the customer's current satisfaction level regarding the service provided by the service provider 102. The satisfaction level regarding the service is an aggregated customer satisfaction for the customer and is determined based on significant events related to the service for the customer. The customer-based satisfaction estimator 308 can receive event-based customer satisfactions from the event-based customer satisfaction score estimator 306 and retrieve significant event configuration 305 for the customer, where the significant event configuration 305 includes information about the significant events and their associated weights. In one example, the significant event configuration 305 is retrieved by the event-based customer satisfaction score estimator 306 and forwarded to the customer-based satisfaction estimator 308. Based on the event-based customer satisfactions and the significant event configuration 305, the customer-based satisfaction estimator 308 may generate the aggregated customer satisfaction for the customer to represent the customer's current satisfaction regarding the service.

Referring to the example above, the customer-based satisfaction estimator 308 may receive the three event-based customer satisfactions Sa, Sb, and Sc from the event-based customer satisfaction score estimator 306, and retrieve significant event configuration 305 including information about the significant events and their associated weights: (a, Wa), (b, Wb), (c, Wc). Each weight Wi associated with a significant event is a coefficient indicative of the importance of the significant event i. Based on the three event-based customer satisfactions Sa, Sb, and Sc and the corresponding weights or coefficients, the customer-based satisfaction estimator 308 may generate an aggregated customer satisfaction S. For example, S may be calculated based on the following formula:

S=Sa*Wa+Sb*Wb+Sc*Wc,

where Wa+Wb+Wc=1, Wa>0, Wb>0, and Wc>0. In accordance with various embodiments, models other than weights can be used to combine the event-based customer satisfactions to generate the aggregated customer satisfaction S.

The customer-based satisfaction estimator 308 can save the aggregated customer satisfaction S in a current time period into a customer-based satisfaction estimate database 309 in the customer satisfaction estimation engine 104. The customer-based satisfaction estimate database 309 in this example stores aggregated customer satisfactions for different customers in different time periods.

The customer satisfaction trend reporter 310 in this example retrieves information from the customer-based satisfaction estimate database 309 and estimates a trend of customer satisfaction of the customer. For example, the customer satisfaction trend reporter 310 may retrieve aggregated customer satisfactions S₁^{T1}, S₁^{T2}, S₁^{T3} in past time periods T1, T2, T3 for customer 1, and estimate a trend of customer satisfaction of the customer using methods like curve fitting and extrapolation. Thus, an aggregated customer satisfaction in a future time period can be predicted based on the trend estimated by the customer satisfaction trend reporter 310. For example, the customer satisfaction trend reporter 310 can estimate the level of satisfaction of Internet users on online services provided by service providers such as Yahoo! and Facebook.

The customer satisfaction trend reporter 310 can generate a customer satisfaction trend report based on the estimated trend. The customer satisfaction trend report may include a trend related warning with respect to the customer. In one example, the trend related warning indicates that the customer is likely to unsubscribe in a near future time period due to a declining trend of his/her satisfaction. Thus, once the service provider 102 receives this warning, the service provider 102 may take some urgent steps to avoid the unsubscribing. In another example, the trend related warning indicates that the customer will enter a high satisfaction region in a near future time period due to an increasing trend of his/her satisfaction. Thus, once the service provider 102 receives this warning, the service provider 102 may try some novel or experimental features of the service without worrying about unsubscribing of the customer. The customer satisfaction trend reporter 310 may send the customer satisfaction trend report to the service provider 102, either periodically or upon request from the service provider 102.

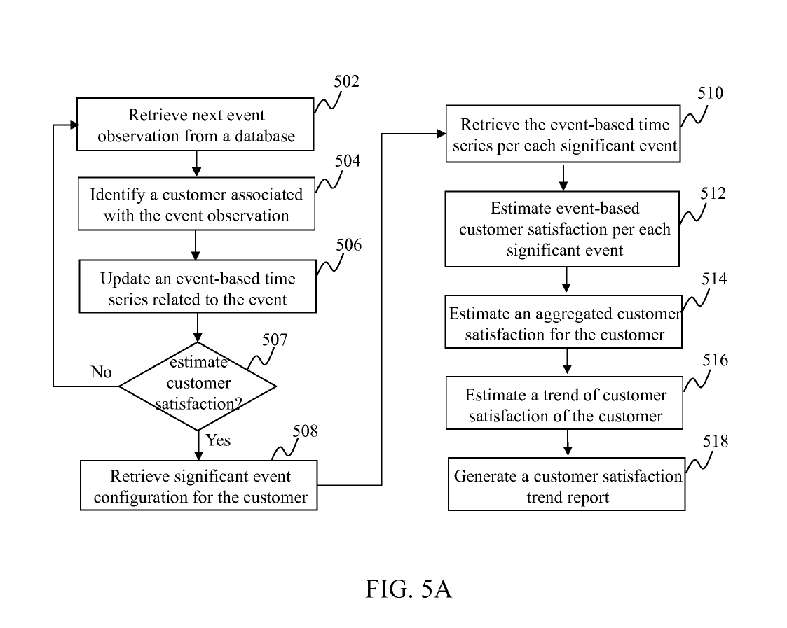

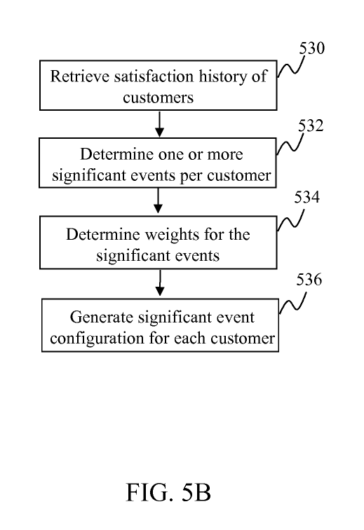

FIG. 5A is a flowchart of an exemplary process performed by a customer satisfaction estimation engine, according to an embodiment of the present teaching. In one example, the exemplary process in FIG. 5A may be performed by the customer satisfaction estimation engine 104 shown in FIG. 3. Starting at 502, an event observation is retrieved from a database, e.g. the event database 110. At 504, a customer associated with the event observation is identified. At 506, an event-based time series related to the event is updated.

At 507, it is determined whether it is time to estimate customer satisfaction. If so, at 508, significant event configuration is retrieved for the customer and the process goes to 510. Otherwise, the process goes back to 502 to retrieve next event observation from the database.

At 510, the event-based time series is retrieved for each significant event. At 512, event-based customer satisfaction is estimated per each significant event. At 514, an aggregated customer satisfaction is estimated for the customer, based on the event-based customer satisfaction(s). At 516, a trend of customer satisfaction of the customer is estimated, e.g. based on aggregated customer satisfactions in different time periods. At 518, a customer satisfaction trend report is generated, e.g. based on the estimated trend.

FIG. 5B is a flowchart of an exemplary process performed by a significant event determiner, e.g. the significant event determiner 304 in the customer satisfaction estimation engine 104, according to an embodiment of the present teaching. The process may be performed offline, without receiving any event related information from a customer in the current time period.

At 530, satisfaction history of customers is retrieved, e.g. from the customer satisfaction history database 109. At 532, one or more significant events are determined per customer. At 534, weights are determined for the significant events. At 536, significant event configuration is generated for each customer, e.g. based on the determined significant events and corresponding weights. In one example, the significant event configuration is generated based on instructions input by a domain expert who has experience regarding relationship between events and customers' satisfaction.

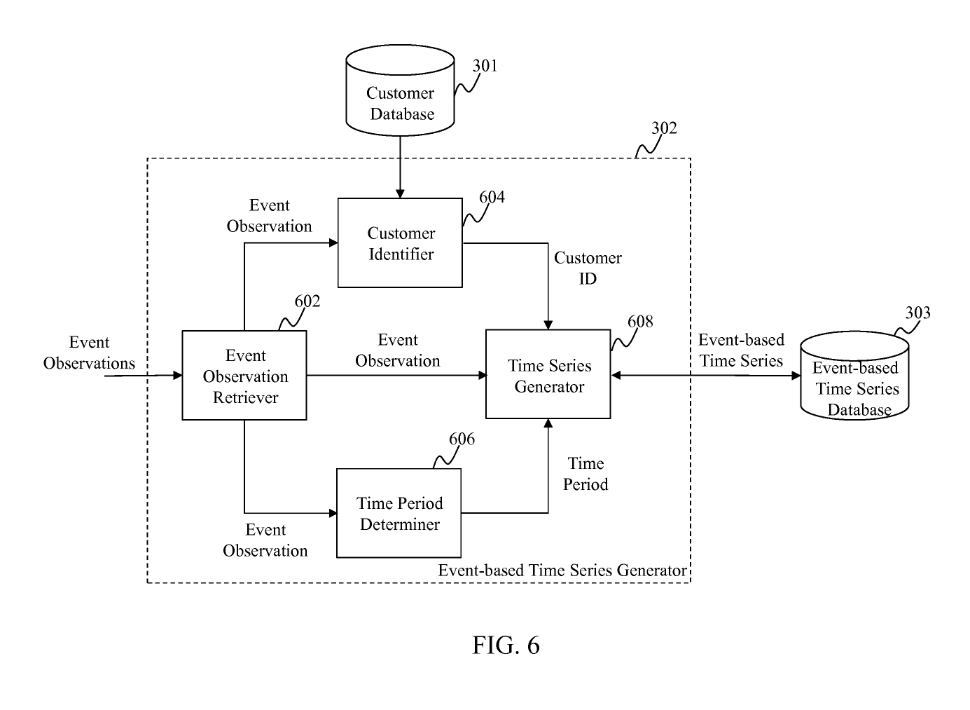

FIG. 6 illustrates an exemplary diagram of an event-based time series generator 302 in a customer satisfaction estimation engine, e.g. the customer satisfaction estimation engine 104, according to an embodiment of the present teaching. The event-based time series generator 302 in this example includes an event observation retriever 602, a customer identifier 604, a time period determiner 606, and a time series generator 608. The event observation retriever 602 in this example retrieves event observations, e.g. from the event database 110. For each retrieved observation, the event observation retriever 602 generates and sends information related to the observation to the customer identifier 604, the time period determiner 606, and the time series generator 608.

The customer identifier 604 in this example receives information related to each observation and identifies a customer associated with the observation based on information related to the observation and information related to customers from the customer database 301. For example, the information related to the observation includes a customer index that can be matched to an index in the customer database 301 for a specific customer. The customer identifier 604 may determine and send a customer ID corresponding to the specific customer to the time series generator 608.

The time period determiner 606 in this example receives information related to each observation and determines a time period associated with the observation based on information related to the observation. For example, the information related to the observation may indicate that the observation was collected in a time period that is three days before current time. Length of a time period may be predetermined. For example, one time period may be equal to a day, an hour, or a minute. The time period determiner 606 may send the determined time period associated with the observation to the time series generator 608.

The time series generator 608 in this example receives information related to each observation from the event observation retriever 602, receives customer ID from the customer identifier 604, and receives the time period associated with the observation from the time period determiner 606. The time series generator 608 generates and/or updates event-based time series for each event associated with a customer. In one example, after receiving 2 observations in a first time period, 3 observations in a second time period, and 6 observations in a third time period, the time series generator 608 may generate a time series: 2, 3, 6, where all of the 11 observations are related to same event associated with same customer. The time series generator 608 may save the event-based time series into the event-based time series database 303. In another example, after receiving another observation that is related to the second time period, the time series generator 608 may retrieve the event-based time series from the event-based time series database 303 and update the time series to be: 2, 4, 6.

As time goes by, the time series may be longer and longer. In one embodiment, maximum length of a time series may be predetermined to be, e.g. 10 or 20. In another embodiment, maximum length of a time series may be determined based on characteristics of the event and/or information about the customer. For example, a new customer may have longer maximum length of a time series than an existing customer, so that more information can be collected for the new customer who does not have many activities with respect to the service yet. In another example, some event like log in may need a maximum length long enough to cover enough counts of occurrences for customer satisfaction assessment, because when a time period is one minute the customer may not have enough times of log in within a normal maximum length like 10 minutes. In one example, the event-based time series generator 302 may keep retrieving event observations and generating/updating the event-based time series stored in the event-based time series database 303. In another example, the event-based time series generator 302 may retrieve event observations and generate/update the event-based time series stored in the event-based time series database 303 for a predetermined period upon request and stop until receiving next request.

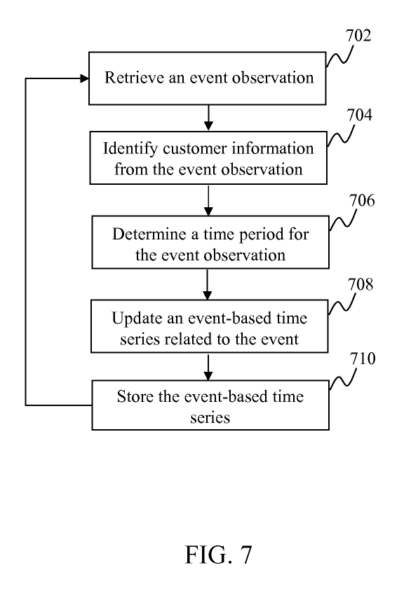

FIG. 7 is a flowchart of an exemplary process performed by an event-based time series generator, e.g. the event-based time series generator 302 in FIG. 6, according to an embodiment of the present teaching. Starting at 702, an event observation is retrieved, e.g. from the event database 110. At 704, customer information is identified from the event observation. At 706, a time period is determined for the event observation. At 708, an event-based time series related to the event is updated. At 710, the event-based time series is stored, e.g. in the event-based time series database 303. The process then goes back to 702 to retrieve another event observation.

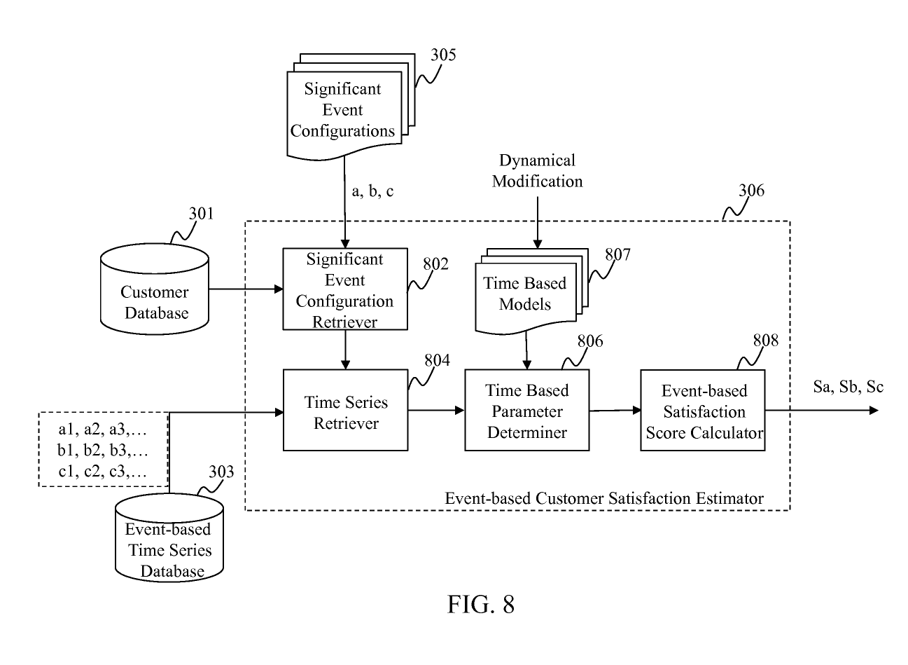

FIG. 8 illustrates an exemplary diagram of an event-based customer satisfaction estimator 306 in a customer satisfaction estimation engine, e.g. the customer satisfaction estimation engine 104, according to an embodiment of the present teaching. The event-based customer satisfaction score estimator 306 in this example includes a significant event configuration retriever 802, a time series retriever 804, a time based parameter determiner 806, and an event-based satisfaction score calculator 808.

The significant event configuration retriever 802 in this example determines whether it is time to estimate customer satisfaction for a customer. The time to estimate satisfaction may be different for different customers. For each customer, satisfaction may be estimated periodically after a predetermined time period, e.g. every day, every hour, or every minute. In another example, satisfaction may be estimated upon request from the service provider 102 for a customer.

After the significant event configuration retriever 802 determines to estimate customer satisfaction for a customer, the significant event configuration retriever 802 may retrieve customer information including customer ID from the customer database 301. Based on the customer information, the significant event configuration retriever 802 can retrieve significant event configuration corresponding to the customer. For example, as shown in FIG. 8, the significant event configuration indicates that the customer is associated with significant events a, b, c. The significant event configuration retriever 802 may forward the significant event configuration to the time series retriever 804.

The time series retriever 804 in this example receives the significant event configuration, identifies the significant events based on the significant event configuration, and retrieves event-based time series from the event-based time series database 303 for each significant event. For example, as shown in FIG. 8, for the significant events a, b, c, the time series retriever 804 retrieves three time series a1, a2, a3, . . . ; b1, b2, b3, . . . ; c1, c2, c3, . . . , respectively. The time series retriever 804 sends the retrieved time series to the time based parameter determiner 806.

The time based parameter determiner 806 in this example receives time series from the time series retriever 804, and selects one of the time based models 807 stored in the event-based customer satisfaction score estimator 306. Each time based model represents a manner to process the time series with consideration of time. For example, a time based model may be a time decay model where an observation in a time period closer to a current time has more effect on the individual measure compared to an observation in a time period further in the past of the same time series. In other examples, a time based model may be a periodic model or any time dependent model. According to a periodic model, for example, observations in a morning time period always have a first same weight; observations in an afternoon time period always have a second same weight; observations in an evening time period always have a third same weight, such that weights for different time periods are in a periodic manner. The time based models 807 may be modified dynamically, e.g. by a manager of the customer satisfaction estimation engine 104.

The time based parameter determiner 806 may determine time based parameter, e.g. time decay, for each event-based time series, based on the selected time based model. The time based parameter determiner 806 then sends the time base parameters along with the event-based time series to the event-based satisfaction score calculator 808. The event-based satisfaction score calculator 808 in this example calculates a customer satisfaction score for each significant event based on the time base parameters and the event-based time series received from the time based parameter determiner 806. As shown in FIG. 8, customer satisfaction scores Sa, Sb, Sc are calculated at the event-based satisfaction score calculator 808 for significant events a, b, c, respectively.

In accordance with one embodiment, the time based parameter determiner 806 determines a difference between each pair of two adjacent observations in the time series, normalizes the difference from each pair of adjacent observations, and computes the individual measure for the time series based on the normalized differences for pairs of adjacent observations. In one example, the difference may be normalized based on the observations in each pair. In another example, the difference may be normalized based on a score determined based on a distance in time between time stamps of the observations in each pair and a time at which the individual measure is estimated.

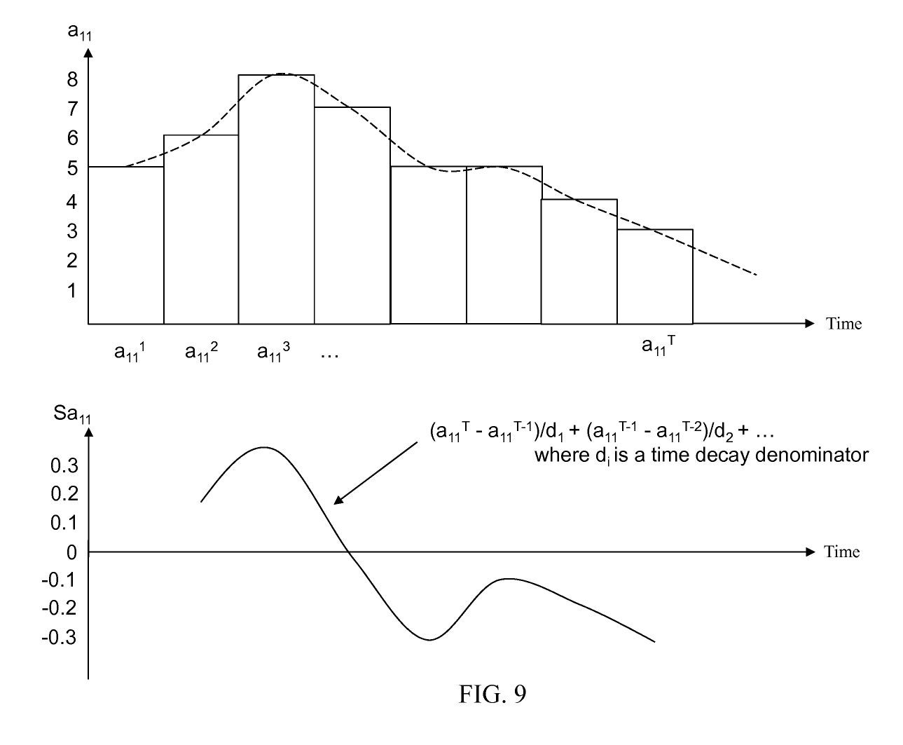

FIG. 9 illustrates one example of time series for observations of an event a₁₁ and the process of computing a corresponding individual measure, i.e., an event-based satisfaction score at different time periods, according to an embodiment of the present teaching. As shown in FIG. 9, in time periods 1, 2, 3 . . . T, the event-based satisfaction scores are a₁₁¹, a₁₁², a₁₁³, . . . a₁₁^{T}, respectively for the event a₁₁. Each event-based satisfaction score represents a count of occurrences of the event a₁₁. In this example, a time decay model is selected so that time decay denominators d₁, d₂, . . . are determined at the time based parameter determiner 806. According to the time decay model, a customer satisfaction score Sa₁₁ may be calculated for the event a₁₁ based on the following formula:

Sa₁₁=(a₁₁^{T}−a₁₁^{T-1})/d₁+(a₁₁^{T-1}−a₁₁^{T-2})/d₂+ . . . +(a₁₁^{T-k+1}−a₁₁^{T-k})/dₖ

where dᵢ is a time decay denominator, i=1, 2, . . . k; k is an integer larger than or equal to one; T represents current time period; T−i represents i time periods before the current time period, i=1, 2, . . . k.

In one example shown in FIG. 9, k=3; d₁=max(a₁₁^{T}, a₁₁^{T-1}), d₂=3*max(a₁₁^{T-1}, a₁₁^{T-2}); and d₃=9*max(a₁₁^{T-2}, a₁₁^{T-3}), where max(a1, a2) represents the maximal number between a1 and a2. FIG. 9 illustrates a curve representing a relationship between current time T and Saᵢ₁ calculated based on the above parameters. The curve may be generated by computing data points of Saᵢ₁ at different time and fitting data points using curve fitting and extrapolation. For example, when current time T=3, Sa₁₁ becomes a high value due to an increase from a₁₁² to a₁₁³; when current time T=4, Sa₁₁ becomes a lower value due to a decrease from a₁₁³ to a₁₁⁴, which is the latest change of counts of occurrences in the time series and hence i contributes more than previous changes according to the time decay model.

It can be understood by one skilled in the art that other time based parameters may be used for the above time based model. For example, k may be a number equal to the maximum length of the time series so that all observations in the time series are utilized to calculate the event-based customer satisfaction score. The time decay denominator may be calculated in other ways, e.g. dᵢ=x*max(a₁₁^{T-i+1}, a₁₁^{T-i}), where x can any real number.

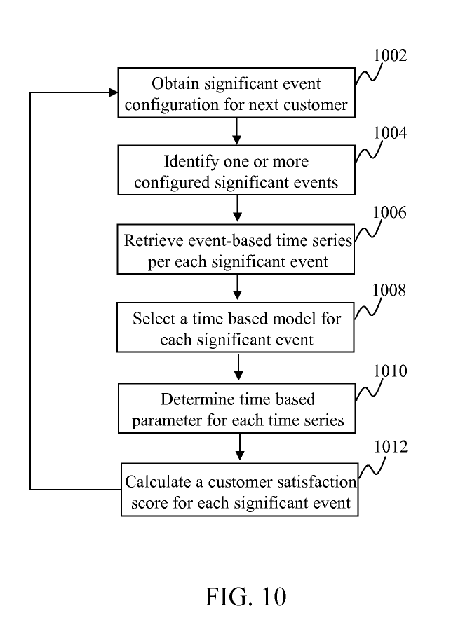

FIG. 10 is a flowchart of an exemplary process performed by an event-based customer satisfaction estimator, e.g. the event-based customer satisfaction estimator 306 in FIG. 8, according to an embodiment of the present teaching. Starting at 1002, significant event configuration is obtained for a customer. At 1004, one or more configured significant events are identified, e.g. based on the significant event configuration. At 1006, event-based time series are retrieved for each significant event. At 1008, a time based model is selected for each significant event. At 1010, time based parameters are determined for each time series, e.g. based on the selected time based model. At 1012, a customer satisfaction score is calculated for each significant event, e.g. based on the time based parameters and the time series. The process then goes back to 1002 to obtain significant event configuration for next customer.

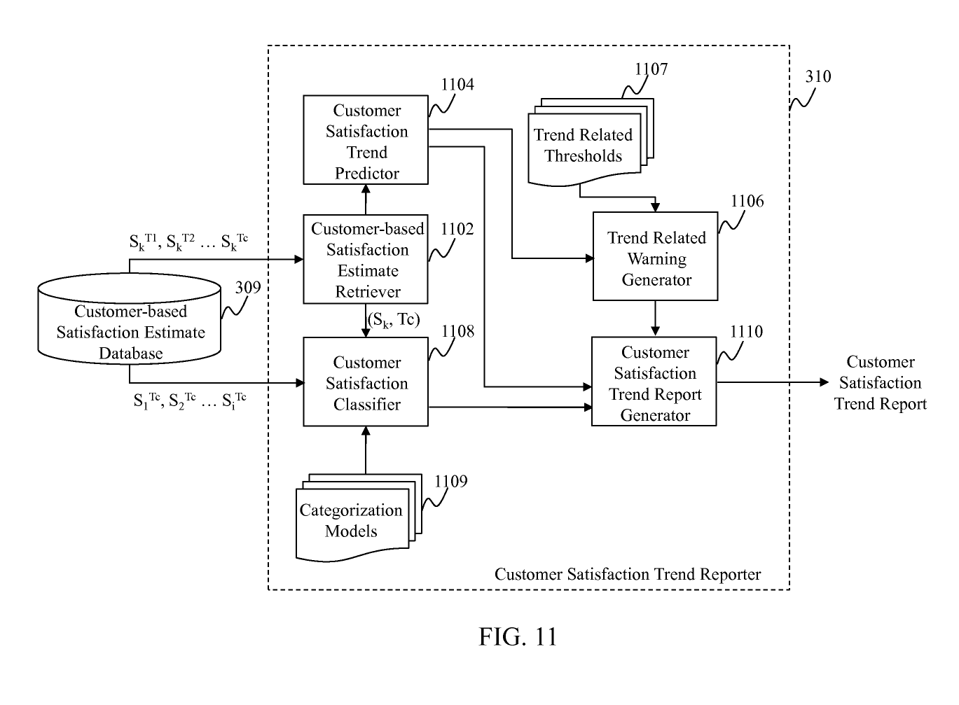

FIG. 11 illustrates an exemplary diagram of a customer satisfaction trend reporter 310 in a customer satisfaction estimation engine, e.g. the customer satisfaction estimation engine 104, according to an embodiment of the present teaching. The customer satisfaction trend reporter 310 in this example includes a customer-based satisfaction estimate retriever 1102, a customer satisfaction trend predictor 1104, a trend related warning generator 1106, a customer satisfaction classifier 1108, and a customer satisfaction trend report generator 1110.

The customer-based satisfaction estimate retriever 1102 in this example retrieves a customer satisfaction time series for a customer k whose satisfaction is of interest and to be reported. As discussed before, based on event-based customer satisfaction scores Sa, Sb, and Sc, and the corresponding significant event configuration (a, Wa), (b, Wb), (c, Wc), the customer-based satisfaction estimator 308 may generate an aggregated customer satisfaction S^{T} for the current time period T, e.g. based on the formula:

S^{T}=Sa*Wa+Sb*Wb+Sc*Wc, where Wa+Wb+Wc=1, Wa>0,Wb>0, Wc>0.

The customer-based satisfaction estimator 308 may save the aggregated customer satisfactions for different customers in different time periods into the customer-based satisfaction estimate database 309. The customer-based satisfaction estimate retriever 1102 may retrieve a customer satisfaction time series for a customer from the customer-based satisfaction estimate database 309. As show in FIG. 11, for example, the customer-based satisfaction estimate retriever 1102 may retrieve the customer satisfaction time series Sₖ^{T1}, Sₖ^{T2} . . . Sₖ^{Tc} for customer k from the customer-based satisfaction estimate database 309, in time periods T1, T2, . . . Tc, where Tc represents the current time period. The customer-based satisfaction estimate retriever 1102 then sends the time series to the customer satisfaction trend predictor 1104.

The customer satisfaction trend predictor 1104 in this example estimates a trend based on the customer satisfaction time series received from the customer-based satisfaction estimate retriever 1102. For example, the customer satisfaction trend predictor 1104 can estimate the level of satisfaction of Internet users on online services provided by service providers such as Yahoo! and Facebook. The trend may also be estimated based on individual measures associated with the customer. Such prediction may be based on an extrapolation of a curve derived by fitting a time series of aggregated measures, e.g. Sₖ^{T1}, Sₖ^{T2} . . . Sₖ^{Tc}, with an analytical model.

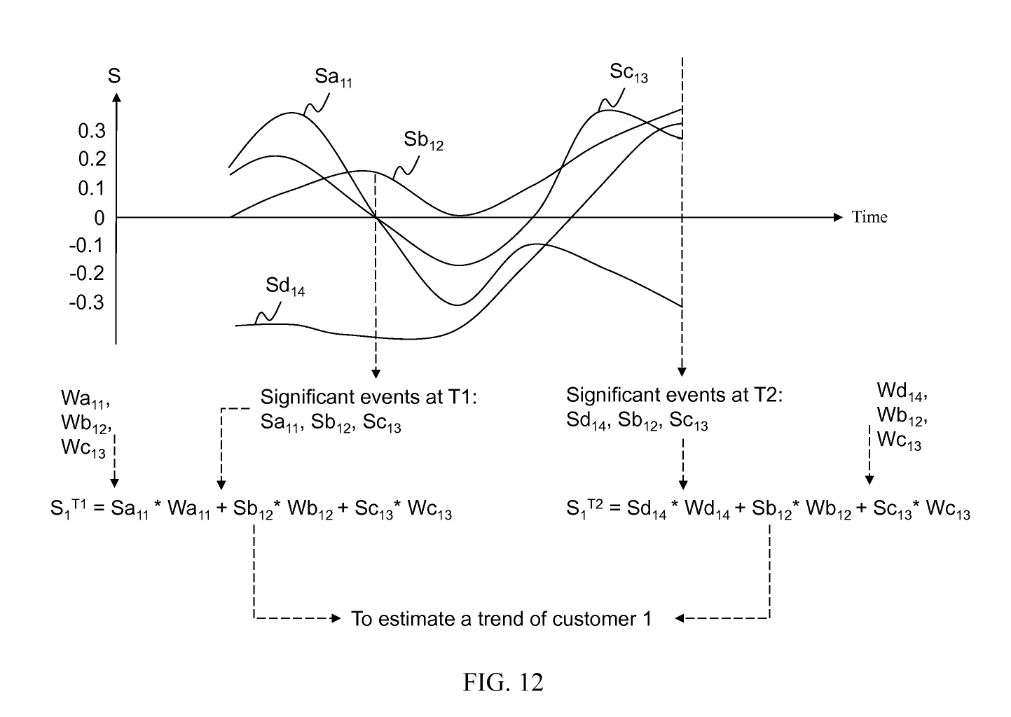

FIG. 12 illustrates one example of trend estimation for customer 1, according to an embodiment of the present teaching. As shown in FIG. 12, different event-based customer satisfaction scores Sa₁₁, Sb₁₂, Sc₁₃, Sd₁₄ may have different relationships with respect to time. At different time points T1 and T2, the aggregated customer satisfactions S₁¹¹ and S₁^{T2} can be calculated based on different significant event configuration. Here, at the time point T1, the significant event configuration indicates significant events to be Sa₁₁, Sb₁₂, Sc₁₃, with weights Wa₁₁, Wb₁₂, Wc₁₃ respectively; at the time point T2, the significant event configuration indicates significant events to be Sd₁₄, Sb₁₂, Sc₁₃, with weights Wd₁₄, Wb₁₂, Wc₁₃ respectively. Thus, the significant event configuration may be different at different time points for the same event, e.g. based on different event-based customer satisfaction scores at different time points. As shown in FIG. 12, the aggregated customer satisfactions S₁^{T1} and S₁^{T2} may be calculated based on the following formulas respectively:

S₁^{T1}=Sa₁₁*Wa₁₁+Sb₁₂*Wb₁₂+Sc₁₃*Wc₁₃;

S₁^{T2}=Sd₁₄*Wd₁₄+Sb₁₂*Wb₁₃+Sc₁₃*Wc₁₃.

As time goes by, more aggregated customer satisfactions can be calculated in a similar manner. Based on the aggregated measures or the aggregated customer satisfactions, the customer satisfaction trend predictor 1104 can estimate a trend of the aggregated customer satisfactions, using e.g. curve fitting and/or extrapolation. The trend can indicate how the customer's satisfaction changes along the time till the current time point. The customer satisfaction trend predictor 1104 can also predict the customer's future satisfaction in next time period, based on the trend of the customer's satisfaction. For example, the customer satisfaction trend predictor 1104 can extrapolate the curve of the customer l's satisfaction in FIG. 12 from the past time periods to a future time period, especially based on the trend of the curve in the latest time periods compared to the current time. The customer satisfaction trend predictor 1104 may send the estimated trend and/or the predicted future customer satisfaction to the trend related warning generator 1106 and the customer satisfaction trend report generator 1110.

The trend related warning generator 1106 in this example receives the estimated trend and/or the predicted future customer satisfaction from the customer satisfaction trend predictor 1104 and may generate a trend related warning with respect to the customer. The trend prediction estimated by the customer satisfaction trend predictor 1104 based on, e.g., extrapolation of a fitted model, may be qualified by the trend related warning generator 1106. For example, if the extrapolation indicates that the next predicted aggregated measure will be higher than the previous one, the qualified classification of the trend prediction can be “upward.”

The customer satisfaction trend predictor 1104 may compare the predicted future customer satisfaction with one or more trend related thresholds 1107 stored in the customer satisfaction trend reporter 310. A trend related threshold may be predetermined based on historical customer satisfaction data, and can be updated dynamically using a machine learning model.

In one example, a first trend related threshold is 0, and the trend related warning generator 1106 generates a first trend related warning if the predicted customer satisfaction in next time period is lower than 0. The first trend related warning here indicates that the customer is likely to unsubscribe in the next time period due to a declining trend of his/her satisfaction. Thus, once the service provider 102 receives this warning, the service provider 102 may take some urgent steps to avoid the unsubscribing.

In another example, a second trend related threshold is 0.5, and the trend related warning generator 1106 generates a second trend related warning if the predicted customer satisfaction in next time period is higher than 0.5. The second trend related warning here indicates that the customer will enter a high satisfaction region in the next time period due to an increasing trend of his/her satisfaction. Thus, once the service provider 102 receives this warning, the service provider 102 may try some novel or experimental features of the service without worrying about unsubscribing of the customer.

The trend related warning generator 1106 may send the generated trend related warning(s) to the customer satisfaction trend report generator 1110 for generating a customer satisfaction trend report.

The customer satisfaction classifier 1108 in this example classifies different customers into different categories that are meaningful for business operation. The customer satisfaction classifier 1108 retrieves customer satisfactions of customers at the current time: S₁^{Tc}, S₂^{Tc} . . . S₁^{Tc}, where i is an integer larger than or equal to one. In one example, the customer satisfaction classifier 1108 retrieves customer satisfactions of all customers at the current time. The customer satisfaction classifier 1108 may receive information about the current time period Tc and the customer satisfaction Sₖ^{Tc} for customer k from the customer-based satisfaction estimate retriever 1102.

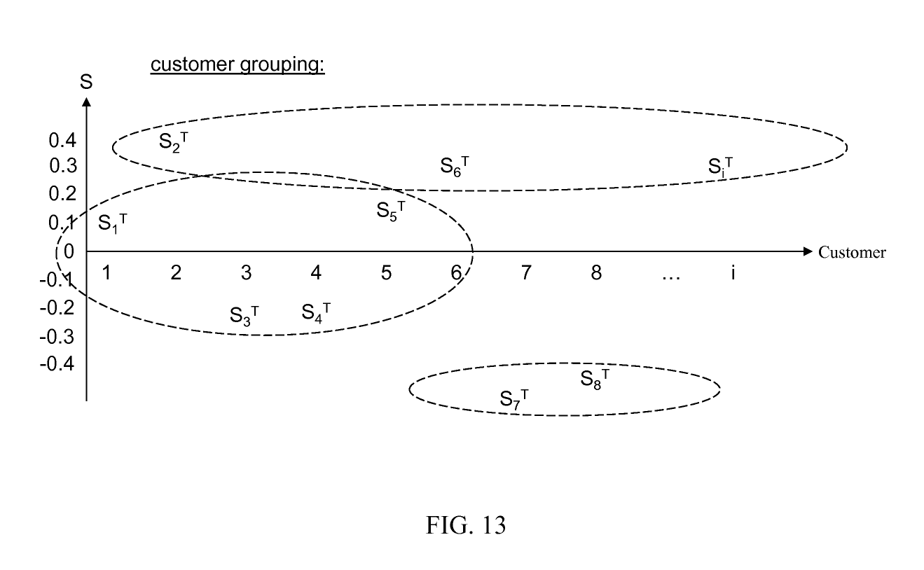

The customer satisfaction classifier 1108 can select one of the categorization models 1109 stored in the customer satisfaction trend reporter 310. A categorization model determines how to group different customers into different categories at a time point, based on their aggregated customer satisfaction scores. FIG. 13 illustrates one example of classifying different customers into different categories, according to an embodiment of the present teaching. As shown in FIG. 13, customers 1, 2, . . . i are classified into three categories based on their customer satisfaction estimates S₁^{T}, S₂^{T}, . . . Sᵢ^{T} at time T. In one example, the customer grouping is performed based on a categorization model indicating some thresholds, where a customer is assigned to a category because the customer's satisfaction estimate at time T is within a range determined by the thresholds. For example, customer 2 is assigned to a top category because S₂^{T} is larger than a threshold 0.3.

In another example, the customer grouping is performed based on a categorization model indicating different percentiles, where a customer is assigned to a category because the customer's satisfaction estimate at time T falls into a range determined by the percentiles compared to other customer's satisfaction estimates at time T. For example, while aggregated measures may fall within a range of [0%, 100%], they are divided into three categories of [0%, 15%], [16%, 75%], and [76%, 100%]. Thus, customers are classified into different categories based on their corresponding aggregated measures. Each of the categories corresponds to a level of customer satisfaction. If customer 2 is assigned to a middle category [16%, 75%] because S₂^{T} can be ranked higher than 65% of all customers' satisfaction estimates at time T, the specific measure of 65% for customer 2 may be qualified as “moderately satisfied” to assist an operator to understand, in qualified terms, the level of satisfaction in a verbal form.

After classifying different customers into different categories, the customer satisfaction classifier 1108 may determine a category for the customer k whose satisfaction is of interest and to be reported. The customer satisfaction classifier 1108 may send information about the determined category to the customer satisfaction trend report generator 1110.

The customer satisfaction trend report generator 1110 in this example receives the estimated trend and/or the predicted future customer satisfaction from the customer satisfaction trend predictor 1104, receives the trend related warning(s) from the trend related warning generator 1106, and receives the determined category for the customer k from the customer satisfaction classifier 1108. The customer satisfaction trend report generator 1110 may generate a customer satisfaction trend report to include at least one of the above information received from the customer satisfaction trend predictor 1104, the trend related warning generator 1106, and the customer satisfaction classifier 1108. The customer satisfaction trend report generator 1110 may send the customer satisfaction trend report, e.g. to the service provider 102, either periodically or in response to a request from the service provider 102. For example, the customer satisfaction trend report generator 1110 may send customer satisfaction trend reports to Internet service providers such as Yahoo! and Facebook, to report satisfaction levels of Internet users of the online services provided by these Internet service providers who care a lot about how to keep their customers, i.e. users of their online services.

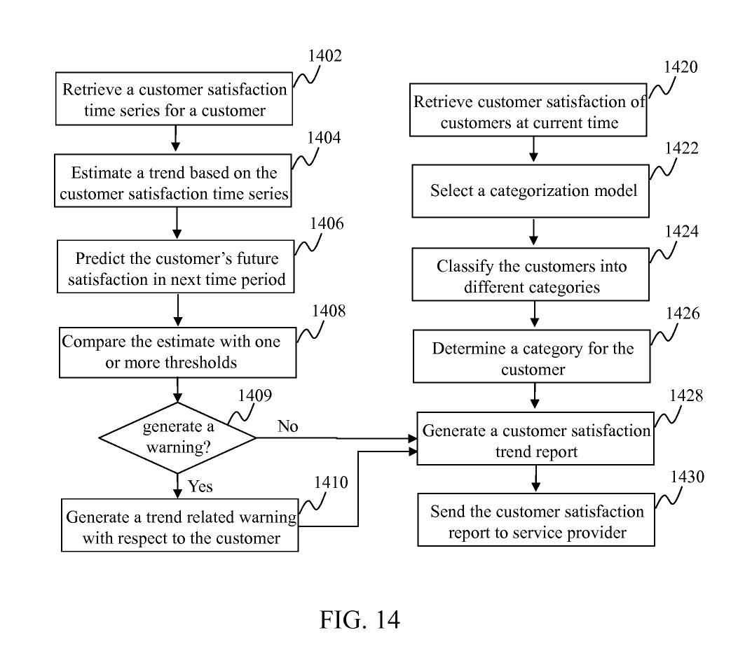

FIG. 14 is a flowchart of an exemplary process performed by a customer satisfaction trend reporter, e.g. the customer satisfaction trend reporter 310 in FIG. 11, according to an embodiment of the present teaching. Starting at 1402, a customer satisfaction time series is retrieved for a customer whose satisfaction is of interest and to be reported. At 1404, a trend is estimated based on the customer satisfaction time series. At 1406, the customer's future satisfaction in next time period is predicted based on e.g. the estimated trend. At 1408, the estimated trend and/or the predicted customer satisfaction may be compared with one or more thresholds.

At 1409, it is determined whether to generate a warning, e.g. based on results of the comparisons at 1408. If so, at 1410, a trend related warning is generated with respect to the customer, and the process goes to 1428. In one example, a plurality of trend related warnings can be generated with respect to the customer. Otherwise, the process goes to 1428 directly.

At 1420, customer satisfactions are retrieved for at least some customers at current time. At 1422, a categorization model is selected. At 1424, the customers are classified into different categories. At 1426, a category is determined for the customer, and the process moves on to 1428.

At 1428, a customer satisfaction trend report is generated, e.g. based on the determined category, the generated warning(s), and the predicted customer satisfaction in next time period for the customer. At 1430, the customer satisfaction report is sent to a service provider, e.g. the service provider 102.

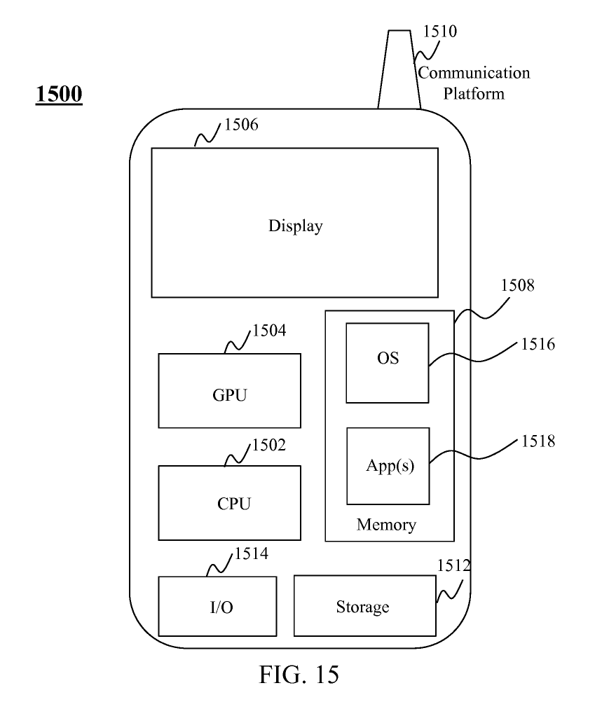

FIG. 15 depicts a general mobile device architecture on which the present teaching can be implemented. In this example, a device of the customer 108 is a mobile device 1500, including but is not limited to, a smart phone, a tablet, a music player, a handled gaming console, a GPS receiver. The mobile device 1500 in this example includes one or more central processing units (CPUs) 1502, one or more graphic processing units (GPUs) 1504, a display 1506, a memory 1508, a communication platform 1510, such as a wireless communication module, storage 1512, and one or more input/output (I/O) devices 1519. Any other suitable component, such as but not limited to a system bus or a controller (not shown), may also be included in the mobile device 1500. As shown in FIG. 15, a mobile operating system 1516, e.g., iOS, Android, Windows Phone, etc., and one or more applications 1518 may be loaded into the memory 1508 from the storage 1512 in order to be executed by the CPU 1502. The applications 1518 may include a web browser or any other suitable mobile search apps. Execution of the applications 1518 may cause the mobile device 1500 to perform some processing as described before. For example, the display of content items and search results is made by the GPU 1504 in conjunction with the display 1506. User inputs of search queries are received via the I/O devices 1514 and sent to a search engine via the communication platform 1510.

To implement the present teaching, computer hardware platforms may be used as the hardware platform(s) for one or more of the elements described herein. The hardware elements, operating systems, and programming languages of such computers are conventional in nature, and it is presumed that those skilled in the art are adequately familiar therewith to adapt those technologies to implement the processing essentially as described herein. A computer with user interface elements may be used to implement a personal computer (PC) or other type of work station or terminal device, although a computer may also act as a server if appropriately programmed. It is believed that those skilled in the art are familiar with the structure, programming, and general operation of such computer equipment and as a result the drawings should be self-explanatory.

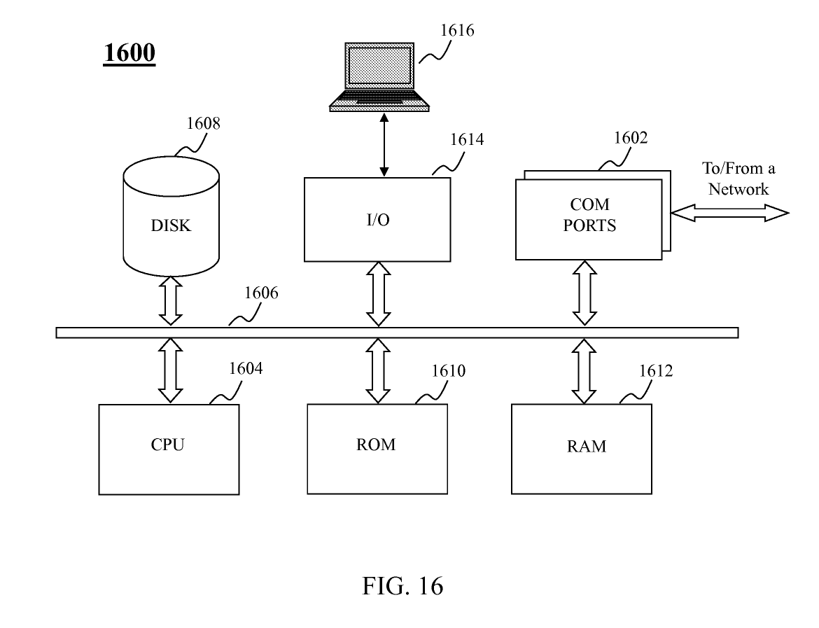

FIG. 16 depicts a general computer architecture on which the present teaching can be implemented and has a functional block diagram illustration of a computer hardware platform that includes user interface elements. The computer may be a general-purpose computer or a special purpose computer. This computer 1600 can be used to implement any components of the customer satisfaction estimation architecture as described herein. Different components of the system, e.g., as depicted in FIGS. 1 and 2, can all be implemented on one or more computers such as computer 1600, via its hardware, software program, firmware, or a combination thereof. Although only one such computer is shown, for convenience, the computer functions relating to customer satisfaction estimation may be implemented in a distributed fashion on a number of similar platforms, to distribute the processing load.

The computer 1600, for example, includes COM ports 1602 connected to and from a network connected thereto to facilitate data communications. The computer 1600 also includes a CPU 1604, in the form of one or more processors, for executing program instructions. The exemplary computer platform includes an internal communication bus 1606, program storage and data storage of different forms, e.g., disk 1608, read only memory (ROM) 1610, or random access memory (RAM) 1612, for various data files to be processed and/or communicated by the computer, as well as possibly program instructions to be executed by the CPU 1604. The computer 1600 also includes an I/O component 1614, supporting input/output flows between the computer and other components therein such as user interface elements 1616. The computer 1600 may also receive programming and data via network communications.

Hence, aspects of the method of customer satisfaction estimation, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software only solution—e.g., an installation on an existing server. In addition, the customer satisfaction estimation engine and its components as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method implemented on a computer having at least one processor, a storage, and a telecommunication platform for estimating customer satisfaction associated with a customer, comprising:
obtaining a plurality of time series, each time series comprising observations for one of a plurality of events associated with the customer, wherein each observation for each of the events is made with respect to a time period;
estimating a plurality of individual measures, each of which is associated with one of the plurality of events, wherein each individual measure is estimated based on a time series including a plurality of observations associated with the event;
receiving information indicative of a number of events selected from the plurality of events; and
computing an aggregated measure indicative of a degree of satisfaction of the customer based on individual measures associated with the number of events.

2. The method according to claim 1, wherein the plurality of events comprises at least one of login, logout, save, click, forward, share, and any combination thereof.

3. The method according to claim 1, wherein an observation of an event includes a number of occurrences of the event during the period of time and/or a time stamp signifying the time at which the observation is made.

4. The method according to claim 3, wherein each time series associated with an event is a list of number of occurrences of the event observed in periods of time.

5. The method according to claim 4, wherein each individual measure corresponding to an event computed based on a time series is estimated by:
determining a difference between each pair of two adjacent observations in the time series;
normalizing the difference from each pair of adjacent observations;
computing the individual measure for the time series based on the normalized differences for pairs of adjacent observations.

6. The method according to claim 5, wherein the step of normalizing is performed based on at least one of (a) the observations in each pair and/or (b) a score determined based on a distance in time between time stamps of the observations in each pair and a time at which the individual measure is estimated.

7. The method according to claim 1, wherein the period of time during which an observation is made is adjustable.

8. The method according to claim 4, wherein the period of time is dynamically adjustable based on at least one criterion.

9. The method according to claim 1, wherein individual measures for the number of events are determined based on their relevance to customer satisfaction.

10. The method according to claim 1, wherein the step of computing comprises:
determining, for each individual measure corresponding to one of the number of events, a coefficient indicative of the importance of the one of the number of events; and
estimating the aggregated measure based on the individual measures associated with the number of events and the coefficients thereof determined.

11. The method according to claim 1, further comprising estimating a trend of the customer satisfaction based on the aggregated measure.

12. The method according to claim 1, further comprising computing aggregated measures indicative of satisfaction of additional customers.

13. The method according to claim 12, further comprising classifying the customer and the additional customers into different categories based on their corresponding aggregated measures, wherein each of the categories corresponds to a level of customer satisfaction.

14. A system having at least one processor, a storage, and a telecommunication platform for estimating customer satisfaction associated with a customer, comprising:
an event-based time series generator configured to obtain a plurality of time series, each time series comprising observations for one of a plurality of events associated with the customer, wherein each observation for each of the events is made with respect to a time period;
an event-based customer satisfaction score estimator configured to estimate a plurality of individual measures, each of which is associated with one of the plurality of events, wherein each individual measure is estimated based on a time series including a plurality of observations associated with the event;
a significant event determiner configured to receive information indicative of a number of events selected from the plurality of events; and
a customer-based satisfaction estimator configured to compute an aggregated measure indicative of a degree of satisfaction of the customer based on individual measures associated with the number of events.

15. The system according to claim 14, wherein the plurality of events comprises at least one of login, logout, save, click, forward, share, and any combination thereof.

16. The system according to claim 14, wherein an observation of an event includes a number of occurrences of the event during the period of time and/or a time stamp signifying the time at which the observation is made.

17. The system according to claim 16, wherein each time series associated with an event is a list of number of occurrences of the event observed in periods of time.

18. The system according to claim 17, wherein the event-based customer satisfaction score estimator comprises an event-based satisfaction score calculator configured to:
determine a difference between each pair of two adjacent observations in the time series;
normalize the difference from each pair of adjacent observations; and
compute the individual measure for the time series based on the normalized differences for pairs of adjacent observations.

19. The system according to claim 18, wherein the difference is normalized based on at least one of (a) the observations in each pair and/or (b) a score determined based on a distance in time between time stamps of the observations in each pair and a time at which the individual measure is estimated.

20. The system according to claim 14, wherein the period of time during which an observation is made is adjustable.

21. The system according to claim 17, wherein the period of time is dynamically adjustable based on at least one criterion.

22. The system according to claim 14, wherein individual measures for the number of events are determined based on their relevance to customer satisfaction.

23. The system according to claim 14, wherein the customer-based satisfaction estimator is further configured to:
determine, for each individual measure corresponding to one of the number of events, a coefficient indicative of the importance of the one of the number of events; and
estimate the aggregated measure based on the individual measures associated with the number of events and the coefficients thereof determined.

24. The system according to claim 14, further comprising a customer satisfaction trend predictor configured to estimate a trend of the customer satisfaction based on the aggregated measure.

25. The system according to claim 14, wherein the customer-based satisfaction estimator is further configured to compute aggregated measures indicative of satisfaction of additional customers.

26. The system according to claim 25, further comprising a customer satisfaction classifier configured to classify the customer and the additional customers into different categories based on their corresponding aggregated measures, wherein each of the categories corresponds to a level of customer satisfaction.

27. A machine-readable tangible and non-transitory medium having information recorded thereon for estimating customer satisfaction associated with a customer, wherein the information, when read by the machine, causes the machine to perform the following:
obtaining a plurality of time series, each time series comprising observations for one of a plurality of events associated with the customer, wherein each observation for each of the events is made with respect to a time period;
estimating a plurality of individual measures, each of which is associated with one of the plurality of events, wherein each individual measure is estimated based on a time series including a plurality of observations associated with the event;
receiving information indicative of a number of events selected from the plurality of events; and
computing an aggregated measure indicative of a degree of satisfaction of the customer based on individual measures associated with the number of events.

28. The medium according to claim 27, wherein the plurality of events comprises at least one of login, logout, save, click, forward, share, and any combination thereof.

29. The medium according to claim 27, wherein an observation of an event includes a number of occurrences of the event during the period of time and/or a time stamp signifying the time at which the observation is made.

30. The medium according to claim 29, wherein each time series associated with an event is a list of number of occurrences of the event observed in periods of time.

31. The medium according to claim 30, wherein each individual measure corresponding to an event computed based on a time series is estimated by:
determining a difference between each pair of two adjacent observations in the time series;
normalizing the difference from each pair of adjacent observations;
computing the individual measure for the time series based on the normalized differences for pairs of adjacent observations.

32. The medium according to claim 31, wherein the step of normalizing is performed based on at least one of (a) the observations in each pair and/or (b) a score determined based on a distance in time between time stamps of the observations in each pair and a time at which the individual measure is estimated.

33. The medium according to claim 27, wherein the period of time during which an observation is made is adjustable.

34. The medium according to claim 30, wherein the period of time is dynamically adjustable based on at least one criterion.

35. The medium according to claim 27, wherein individual measures for the number of events are determined based on their relevance to customer satisfaction.

36. The medium according to claim 27, wherein the step of computing comprises:
determining, for each individual measure corresponding to one of the number of events, a coefficient indicative of the importance of the one of the number of events; and
estimating the aggregated measure based on the individual measures associated with the number of events and the coefficients thereof determined.

37. The medium according to claim 27, the information, when read by the machine, further causing the machine to estimate a trend of the customer satisfaction based on the aggregated measure.

38. The medium according to claim 27, the information, when read by the machine, further causing the machine to compute aggregated measures indicative of satisfaction of additional customers.

39. The medium according to claim 38, the information, when read by the machine, further causing the machine to classify the customer and the additional customers into different categories based on their corresponding aggregated measures, wherein each of the categories corresponds to a level of customer satisfaction.
